(19) United States
(12) Patent Application Publication
(10) Pub. No.: US 2012/0033114 A1
(43) Pub. Date: Feb. 9, 2012

(54) ACTIVE DEVICE ARRAY SUBSTRATE

(75) Inventors: Min-Hsiang Hung, Tainan City (TW); Ming-Yung Huang, Hsinchu County (TW); Chun-Jen Chiu, Taichung City (TW); Yu-Zhi Wu, Nantou County (TW); Yuan-Nan Chiu, Yunlin County (TW); Chin-An Tseng, Taipei City (TW); Yen-Heng Huang, Taipei County (TW)

(73) Assignee: AU OPTRONICS CORPORATION, Hsinchu (TW)

(21) Appl. No.: 12/955,923

(22) Filed: Nov. 30, 2010

(30) Foreign Application Priority Data
Aug. 5, 2010 (TW) 99126130

(51) Int. Cl. H04N 5/335

(52) U.S. Cl. 348/273; 348/E05.091

(57) ABSTRACT

An active device array substrate including a substrate, multiple scan lines, multiple data lines, multiple of pixels are provided. The scan lines and the data lines are disposed on the substrate. Each pixel includes multiple sub-pixels including at least a transistor, a pixel electrode, and a color filter. The transistor is disposed on the substrate and electrically connected to the scan line and the data line correspondingly. A portion of the color filter is disposed between the pixel electrode and the corresponding scan line. The pixel electrode is coupled with the corresponding scan line to form a first capacitor. The drain of the transistor is coupled with the corresponding scan line to form a second capacitor. In a single pixel, the coupling areas of the pixel electrodes corresponding to various color filters with the corresponding scan lines are different, so that capacitance of the first capacitors are substantially the same.

### CROSS-REFERENCE TO RELATED APPLICATION

This application claims the priority benefit of Taiwan application serial no. 99126130, filed on Aug. 5, 2010. The entirety the above-mentioned patent application is hereby incorporated by reference herein and made a part of specification.

### BACKGROUND

1. Field of the Disclosure

The present invention relates to an array substrate, and more particularly to an active device array substrate.

2. Description of Related Art

The rapid development of the multi-media society is mostly benefited from the great advancement of semiconductor module or display apparatus. In the past, cathode ray tubes (CRT) have been the dominant displays in the market for their excellent displaying performance and economic advantages. However, in view of monitoring a plurality of desktop terminals/displays simultaneously by a single individual or the advent of the concept of environmental protection, the bulk and the power consumption of a CRT have created a number of problems. The CRT cannot effectively meet the demands on features such as light weight, thinness, small size and low power consumption and there are very few options for streamlining the dimension and reducing the power consumption of a CRT display apparatus. Therefore, liquid crystal display (LCD) devices having the advantages of higher image quality, optimal space efficiency, low power consumption and non-radiation have become the mainstream in the market.

Generally speaking, subsequent to the fabrication of a liquid crystal display (LCD) panel, tests are normally performed on the LCD panel to determine whether its functions are normal. Using a LCD panel of a color filter on array (COA) technology as an example, during the image sticking test, slight image sticking appears to a COA LCD panel, and the displayed image also appear to have a color shift problem. Moreover, during the display of a checkerboard testing pattern with alternate black-and-white patterns by the COA display panel, the white patterns appear purplish. Moreover, during the display of the pure color patterns of red, green, blue, the image sticking of the red and blue patterns is more distinct than that of the green pattern.

### SUMMARY OF THE DISCLOSURE

The following disclosure is directed to an active device array substrate, in which color shift and image sticking of a display panel can be mitigated.

An exemplary embodiment of the disclosure provides an active device array substrate that includes a substrate, a plurality of scan lines, a plurality of data lines and a plurality of pixels. The scan lines and the data lines are disposed on the substrate, wherein the scan lines and the data lines intersect to form a plurality of sub-pixel regions on the substrate. Each pixel includes a plurality of sub-pixels, and each sub-pixel is respectively disposed within one of the sub-pixel regions. Each sub-pixel includes at least a transistor, a pixel electrode and a color filter. The transistor includes a gate electrically connected to a corresponding scan line, a source electrically connected to a corresponding data line, and a drain. The pixel electrode and the drain are electrically connected. The color filter is disposed within one of the sub-pixel regions and under the pixel electrode, wherein a portion of the color filter is disposed between the pixel electrode and the scan line. The pixel electrode and the corresponding scan line are coupled to form a first capacitor, and the drain and the corresponding scan line are coupled to form a second capacitor. In a single pixel, the coupling areas of the pixel electrodes corresponding to various color filters and the corresponding scan lines are substantially different so that the capacitance of the first capacitors are substantially the same, and the capacitance of the second capacitors of the sub-pixels are substantially the same.

In one exemplary embodiment of the invention, in the above single pixel, the color filters include at least a first color filter, a second color filter and a third color filter, and the dielectric constant of the first color filter is ∈1, the dielectric constant of the second color filter is ∈2, and the dielectric constant of the third color filter is ∈3, and the thickness of the first color filter is D1, the thickness of the second color filter is D2, the thickness of the third color filter is D3. Further, the pixel electrodes include a first pixel electrode, a second pixel electrode, and a third pixel electrode, and the coupling area of the first pixel electrode and the corresponding scan line is A1, the coupling area of the second pixel electrode and the corresponding scan line is A2, the coupling area of the third pixel electrode and the corresponding scan line is A3, and a following relation is satisfied:

[(∈1×A1)/D1]=[(∈2×A2)/D2]=[(∈3×A3)/D3].

According to an exemplary embodiment of the disclosure, ∈1≠∈2≠∈3.

According to the exemplary embodiment of the disclosure, D1D2≠D3.

According to an exemplary embodiment of the disclosure, ∈1≠∈≠∈3 and D1≠D2≠D3.

Another exemplary embodiment of the disclosure provides an active device array substrate including a substrate, a plurality of scan lines, a plurality of data lines and a plurality of pixels. The scan lines are disposed on the substrate and the data lines are disposed on the substrate, wherein the scan lines and the data lines intersect to form a plurality of sub-pixel regions on the substrate. Each pixel includes a plurality of sub-pixels, and each sub-pixel is respectively disposed within one of the sub-pixel regions. Each sub-pixel includes at least a transistor, a pixel electrode and a color filter. The transistor is disposed on the substrate and is electrically connected to the corresponding scan line and data line. The transistor includes a gate that is electrically connected to the corresponding scan line, a source that is electrically connected to the corresponding data line, and a drain. The pixel electrode is electrically connected to the drain. The color filter is configured within one of the sub-pixel regions, under the pixel electrode, wherein a part of the color filter is positioned between the pixel electrode and the scan line, the pixel electrode and the corresponding scan line are coupled to form a first capacitor, and the drain the corresponding scan line are coupled to form a second capacitor. In a single pixel, different color filters lead to the capacitance of the first capacitors (first capacitance) to be substantially different and the capacitance of the second capacitors (second capacitance) of the sub-pixels are substantially different. Further, the sum of the first capacitance and the second capacitance of each sub-pixel is substantially the same as the sum of the first capacitance and the second capacitance of the other sub-pixels.

In an exemplary embodiment of the disclosure, in the above single pixel, the color filters comprise at least a first color filter, a second color filter, and a third color filter, and a dielectric constant of the first color filter is ∈1, a dielectric constant of the first color filter is ∈2, a dielectric constant of the first color filter is ∈3, and the thickness of the first color filter is D1, the thickness of the second color filter is D2, the thickness of the third color filter is D3. Moreover, the second capacitance of the sub-pixel having the first color filter is Cg1, the second capacitance of the sub-pixel having the second color filter is Cg2, the second capacitance of the sub-pixel having the third color filter is Cg3, and a following relation is satisfied:

[[(∈1×A)/D1]+Cg1]=[[(∈2×A)/D2]+Cg2]=[[(∈3×A)/D3]+Cg3].

According to an exemplary embodiment of the disclosure, in the above single pixel, the coupling area of each drain and the corresponding scan line is substantially different from the coupling areas of other drains and the corresponding scan lines.

According to active device array substrate of the disclosure, the coupling areas of the pixel electrode corresponding to the different color filters and the corresponding scan lines are different, so that the first capacitance of the different sub-pixels are substantially the same, and the second capacitance of the sub-pixels are substantially the same. Alternatively, the first capacitance corresponding to the different color filters are different, the second capacitance of the sub-pixels are made to be different, and the sum of the first capacitance and the second capacitance of each sub-pixel is substantially the same as the sum of the first capacitance and the second capacitance of the other sub-pixels. Accordingly, color shift and image sticking of an image could be suppressed.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 is a waveform diagram of the voltage of a pixel electrode in an active device array substrate and the driving voltage according to an exemplary embodiment of the disclosure.

FIG. 2 is a schematic diagram of an active device array substrate according to an exemplary embodiment of the disclosure.

FIG. 3 is a cross-sectional diagram of FIG. 2, along the cutting line A-A′.

FIG. 4 is a schematic diagram of an active device array substrate according to another exemplary embodiment of the disclosure.

### DESCRIPTION OF EMBODIMENTS

Because color shift and image sticking often occur in a conventional COA liquid crystal display panel, in the following exemplary embodiments, the common voltage of a white image, a red image, a green image and a blue image displayed by a COA liquid crystal display panel is estimated to identify the reasons for the occurrence of color shift and image sticking.

In a typical driving technology, such as dot inversion, column inversion, row inversion or frame inversion, the voltage levels of a positive half-cycle signal and a negative half-cycle signal that are alternatively input to the pixel electrode are lower due to the feed through effect when the gate (scan line) is turned off. Theoretically speaking, the difference in the feed through effect on a pixel electrode in the sub-pixels for displaying different colors is not significant. However, in reality, in a COA liquid crystal display panel, the coupling effect between the pixel electrode in the sub-pixels for displaying different colors and the gate (scan line) is directly related to the color filter. More specifically, when the dielectric constants and/or the thicknesses of the red, green, blue color filters used are substantially different, the sub-pixels for displaying different colors are affected by the different feed through effects, leading to the color shift phenomenon.

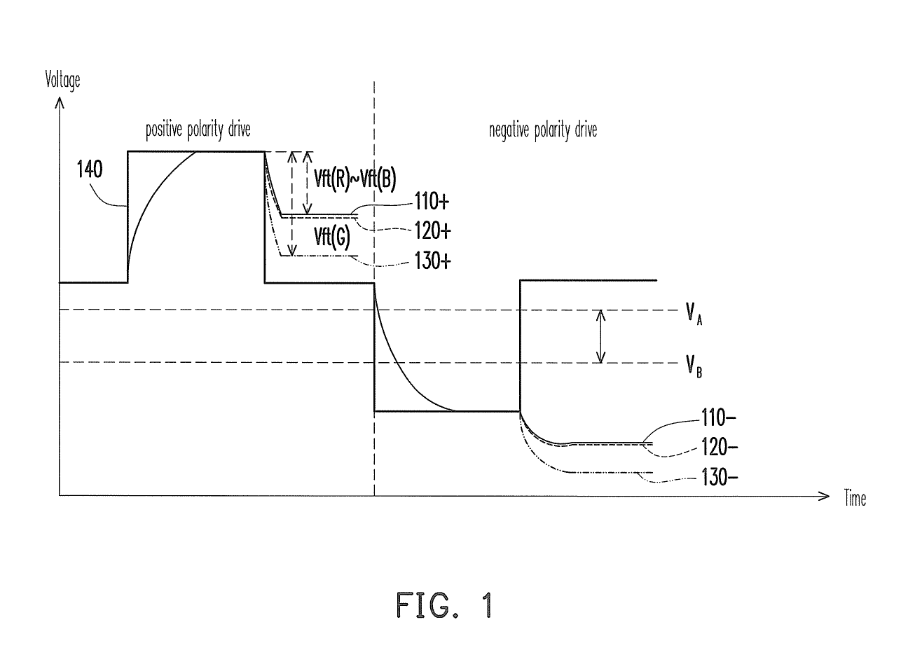

FIG. 1 is a waveform diagram of the voltage of a pixel electrode in an active device array substrate and the driving voltage according to an exemplary embodiment of the disclosure. Referring to FIG. 1, a single pixel typically includes three sub-pixels, which are the red pixel, the green pixel, and the blue pixel. The waveform 140 is a voltage waveform of the driving voltage of the input data line, 110+ is the voltage waveform of the pixel electrode of the red sub-pixel at the positive half cycle, 110− is the voltage waveform of the pixel electrode of the red sub-pixel at the negative half cycle, 120+ is the voltage waveform of the pixel electrode of the blue sub-pixel at the positive half cycle, 120− is the voltage waveform of the pixel electrode of the blue sub-pixel at the negative half cycle, 130+ is the voltage waveform of the pixel electrode of the green sub-pixel at the positive half cycle, 130− is the voltage waveform of the pixel electrode of the green sub-pixel at the negative half cycle.

According to FIG. 1, the feed through voltage Vft(R) of the red sub-pixel and the feed through voltage Vft(B) of the blue sub-pixel are approximate but different. According to FIG. 1, for the red sub-pixel and the blue sub-pixel, the most favorable common voltage (optimum voltage or best voltage) is voltage V_{A}, while for the green sub-pixel, the most favorable common voltage (optimum voltage or best voltage) is voltage V_{B}, wherein the most favorable common voltage of the red sub-pixel is substantially higher than the most favorable common voltage of the green sub-pixel. Accordingly, since the feed through voltage Vft(R) of the red sub-pixel is substantially smaller than the feed through voltage Vft(B) of the blue sub-pixel, image sticking of the red sub-pixel and the blue sub-pixel is more distinct. To suppress color shift and image sticking of an image, the feed through voltages Vft(R), Vft(B), Vft(G) must be substantially the same. It is worthy to note that the exemplary embodiments of the invention may be applied to a plurality sub-pixels (not limited to three sub-pixels), and are not limited to the situation of Vft(G)>Vft(R)÷Vft(G).

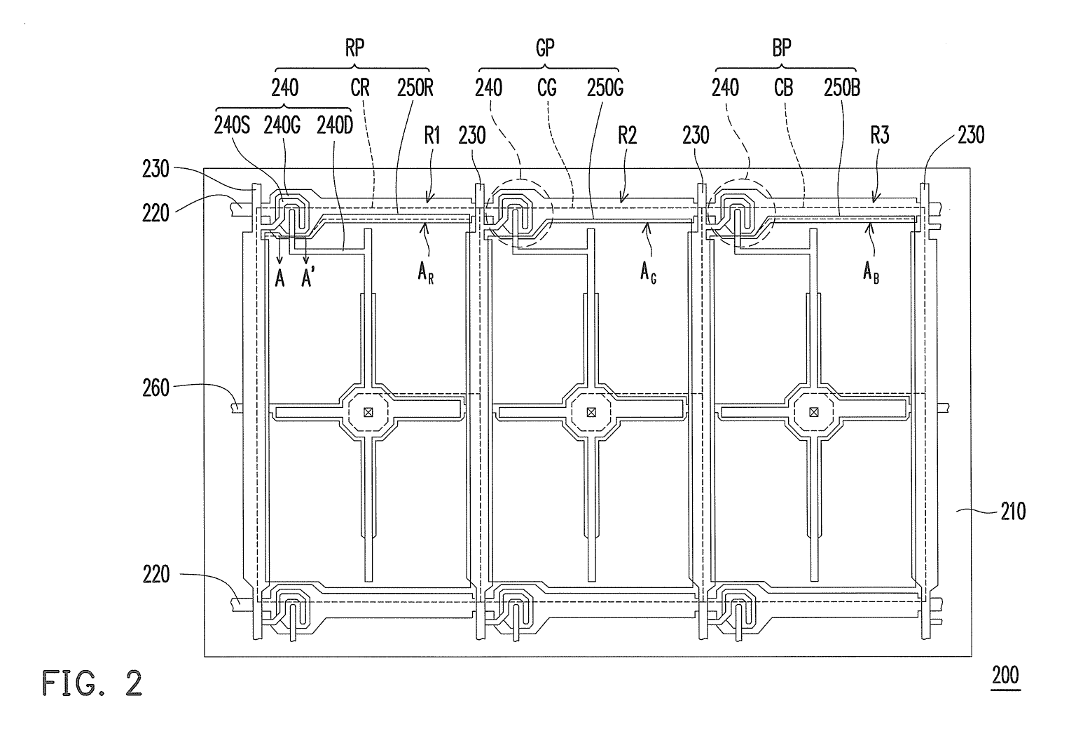

FIG. 2 is a schematic diagram of an active device array substrate according to an exemplary embodiment of the disclosure. Referring to FIG. 2, the active device array substrate 200 includes a substrate 210, a plurality of scan lines 220, a plurality of data lines 230, a plurality of transistors 240, a plurality of pixel electrodes (such as 250R, 250G and 250B), at least one common line 260 and a plurality of color filters (such as CR, CG and CB). The scan line 220 and the data line 230 intersect to define a plurality of sub-pixel regions (such as R1, R2 and R3) on the substrate 210.

The transistor 240 is electrically connected to the corresponding scan line 120 and the corresponding date line 130. Each pixel electrode (such as 250R, 250G, and 250B) is positioned in the corresponding sub-pixel region (such as R1, R2, and R3), and is electrically connected to the corresponding transistor 240. Each color filter (such as CR, CG and CB) is disposed in one of the sub-pixel region (such as R1, R2, and R3) and is configured under the pixel electrode (such as 250R, 250G, and 250B). Further, a portion of the color filter (such as CR, CG and CB) is positioned between the corresponding pixel electrode (such as 250R, 250G, and 250B) and the scan line 220.

As shown in FIG. 2, each transistor 240 includes a gate 2406, a source 240S, and a drain 240D, wherein the gate 240G is electrically connected to the corresponding scan line 220, the source 240S is electrically connected to the corresponding data line 230, and the drain 240D is electrically connected to the corresponding pixel electrode (such as 250R, 250G, and 250B). Moreover, the common line 260 in this exemplary embodiment of the disclosure is positioned below the pixel electrode (such as 250R, 250G, and 250B), for example, and is coupled with the pixel electrode (such as 250R, 250E and 250B) to form a storage capacitor. In addition, the pixel electrode (such as 250R, 250G, and 250B) partially overlaps with the neighboring data line 230.

In this exemplary embodiment, the color filter CR is a red color filter, and together with the corresponding transistor 240 and the corresponding pixel electrode 250R forms a red sub-pixel RP; the color filter CG is a green color filter, and together with the corresponding transistor 240 and the corresponding pixel electrode 250G forms a green sub-pixel GP; the color filter CB is a blue color filter, and together with the corresponding transistor 240 and the corresponding pixel electrode 250B forms a blue sub-pixel BP. The red sub-pixel RP, the green sub-pixel GP and the blue sub-pixel GP together constitute a pixel. Although the disclosure herein refers to certain illustrated embodiments of a pixel including three sub-pixels, it is appreciated that the number of sub-pixels in a pixel is not restricted.

For the red sub-pixel RP, the mathematical relation of the feed through voltage Vft(R) is expressed below:

$$Vft ( R ) = VG \times ( \frac{Cgd ( R )}{Cst + Clc + Cpd + Cgs + Cgd ( R )} )$$

wherein VG is the voltage difference between the high voltage and the low voltage that are sent to the scan line 220, Cst is the storage voltage, Clc is the liquid crystal capacitance, Cpd is the capacitance of the coupling capacitor between the pixel electrode 250R and the neighboring data line 230, Cgs is the capacitance of the parasitic capacitor between the gate 240G of the transistor 240 (which is the scan line 220) and the source electrode 240S, Cgd(R) is the capacitance of the parasitic capacitor between the gate 240G of the transistor 240 and the drain 240D.

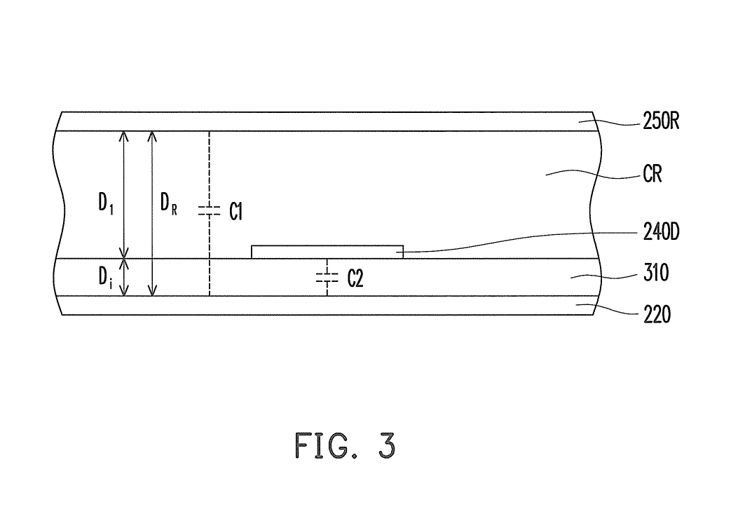

FIG. 3 is a cross-sectional diagram of FIG. 2, along the cutting line A-A′. Referring to both FIGS. 2 and 3, in the red sub-pixel RP, since the pixel electrode 250R is electrically connected to the drain 240D, the pixel electrode 250R and the drain 240D substantially have the same electrical potential. Accordingly, the parasitic capacitor between the gate 240G of the transistor 240 and the drain 240D includes the first capacitor C1 formed by the coupling of the pixel electrode 250R and the scan line 220 and the second capacitor C2 formed by the coupling of the drain 240D and the scan line 220. As shown in FIG. 3, a red color filter CR and an insulation layer 310 are disposed between the pixel electrode 250R and the scan line 220. Hence, the capacitance of the first capacitor is equal to [(∈_{R}×A_{R})/D_{R}], wherein ∈_{R} is the dielectric constant of the first capacitor C1 and is related to the dielectric constant ∈₁ of the red color filter CR and the dielectric constant ∈ᵢ of the insulation layer 310; A_{R} is the coupling area of the pixel electrode 250R and the scan line 220; D_{R} is the distance between the pixel electrode 250R and the scan line 220 and is the sum of the thickness D₁ of the red color filter C_{R} and the thickness Dᵢ of the insulation layer 310. Further referring to FIG. 3, the insulation 310 is disposed between the drain 240D and the scan line 220, and the capacitance of the second capacitor C2 is equal to [(∈ᵢ×A_{D})/Dᵢ], wherein A_{D} is the coupling area of the drain region 240D and the san line 220.

The structures of the green sub-pixel and the blue sub-pixel are similar to that of the red sub-pixel. Hence, based on the cross-sectional diagram of the red sub-pixel, the mathematical relations of the feed through voltage Vft(G) and the feed through voltage Vft(B) may be deduced from the cross-sectional diagram of the red sub-pixel:

$$Vft ( G ) = VG \times ( \frac{Cgd ( G )}{Cst + Clc + Cpd + Cgs + Cgd ( G )} )$$

$$Cgd ( G ) = {ɛ}_{G} \times ( \frac{{A}_{G}}{{D}_{G}} ) + {ɛ}_{i} \times ( \frac{{A}_{D}}{{D}_{i}} )$$

$$Vft ( B ) = VG \times ( \frac{Cgd ( B )}{Cst + Clc + Cpd + Cgs + Cgd ( B )} )$$

$$Cgd ( B ) = {ɛ}_{B} \times ( \frac{{A}_{B}}{{D}_{B}} ) + {ɛ}_{i} \times ( \frac{{A}_{D}}{{D}_{i}} )$$

wherein, ∈_{G} is the dielectric constant of the first capacitor C1 in the green sub-pixel GP and is related to the dielectric constant ∈₂ of the green color filter CG and the dielectric constant ∈ᵢ of the insulation layer 310, and A_{G} is the coupling area of the pixel electrode 250G and the scan line 220, D_{G} is the distance between the pixel electrode 250G and the scan line 220 and is also substantially equal to the sum of the thickness D₂ of the green color filter CG and the thickness Dᵢ of the insulation layer 310; ∈_{B} is the dielectric constant of the first capacitor C1 in the blue sub-pixel BP and is related to the dielectric constant ∈₃ of the blue color filter CB and the dielectric constant ∈ᵢ of the insulation layer 310, and A_{B} is the coupling area of the pixel electrode 250B and the scan line 220, D_{B} is the distance between the pixel electrode 250B and the scan line 220 and is also substantially equal to the sum of the thickness D₃ of the blue color filter CB and the thickness Dᵢ of the insulation layer 310.

Additionally, since the materials used in forming the red color filter CR, the green color filter CG and the blue color filter CB are different, the dielectric constants are also different ∈₁≠∈₂≠∈₃. Further, in order to adjust the intensity of the displayed color, the thicknesses of the color filters are usually different D₁≠D₂≠D₃. Accordingly, the major reason that causes the feed through voltages Vft(R)·Vft(G) and Vft(R) to be different is the parasitic capacitance Cgd(R)·Cgd(G) and Cgd(B). Hence, during the design of the above parasitic capacitors, one may select modifying at least the dielectric constant (∈) or the thickness (D) of the color filter. Alternatively, the above two parameters (the dielectric constant (∈) or the thickness (D) of the color filter) are modified concurrently. Moreover, since the capacitance of the second capacitors C2 in the red sub-pixel RP, the green sub-pixel GP and the blue sub-pixel BP are substantially the same, the capacitance of the first capacitor C1 in the red sub-pixel RP, the green sub-pixel GP and the blue sub-pixel are adjusted to be the same and the follow relation is satisfied:

$${ɛ}_{R} \times ( \frac{{A}_{R}}{{D}_{R}} ) = {ɛ}_{G} \times ( \frac{{A}_{G}}{{D}_{G}} ) = {ɛ}_{B} \times ( \frac{{A}_{B}}{{D}_{B }} )$$

Further, according to the above disclosure, the above relations may be replaced by the following relations:

$${ɛ}_{1} \times ( \frac{{A}_{R}}{{D}_{1}} ) = {ɛ}_{2} \times ( \frac{{A}_{G}}{{D}_{2}} ) = {ɛ}_{3} \times ( \frac{{A}_{B}}{{D}_{3}} )$$

Referring to FIG. 2, in this exemplary embodiment of the disclosure, to suppress color shift and the image sticking of an image, the feed through voltages Vft(R) and Vft(B) are adjusted to approach the feed through voltage Vft(G), which means the coupling areas would be A_{R}>A_{B}>A_{G}. The increased coupling area as shown in the Figure is for illustration purpose, the coupling area may not be actually increased.

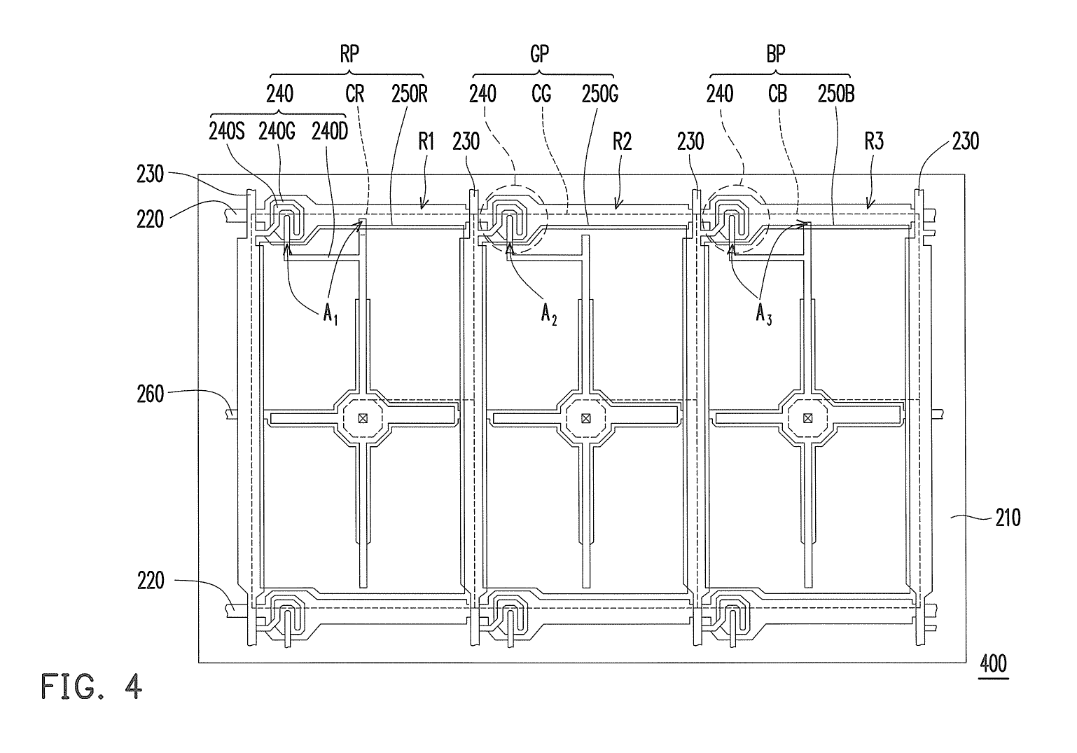

FIG. 4 is a schematic diagram of an active device array substrate according to another exemplary embodiment of the disclosure. Referring to both FIGS. 2 and 4, the coupling area A_{R}, A_{B}, A_{G} are set to be substantially the same in this exemplary embodiment. Further, by adjusting the capacitance of the second capacitor C2 in the red sub-pixel RP, the green sub-pixel GP and the blue sub-pixel, respectively, the parasitic capacitance Cgd(R)·Cgd(G) and Cgd(B) would be substantially the same and satisfy the following relations:

$$\begin{matrix}[ {ɛ}_{R} \times ( \frac{{A}_{R}}{{D}_{R}} ) + {ɛ}_{i} \times ( \frac{{A}_{1}}{{D}_{i}} ) ] = [ {ɛ}_{G} \times ( \frac{{A}_{G}}{{D}_{G}} ) + {ɛ}_{i} \times ( \frac{{A}_{2}}{{D}_{i}} ) ] \\ = [ {ɛ}_{B} \times ( \frac{{A}_{B}}{{D}_{B}} ) + {ɛ}_{i} \times ( \frac{{A}_{3}}{{D}_{i}} ) ] ,\end{matrix}$$

wherein A1 is the coupling area of the drain 240D in the red sub-pixel RP and the scan line 220, A2 is the coupling area of the drain 240D in the green sub-pixel and the scan line 220, and A3 is the coupling area of the drain 240D in the blue sub-pixel BP and the scan line 220. Further, to suppress color shift and image sticking of an image, the feed through voltages Vft(R) and Vft(B) are made to approach the feed through voltage Vft(G), which means the coupling areas would be A1>A3>A2. The increased coupling area as shown in the Figure is for illustration purpose, the coupling area may not be actually increased.

In accordance to the active device array substrate in the exemplary embodiments of the above disclosure, the coupling areas of the pixel electrode corresponding to the different color filters and the scan line could be different, so that the capacitance of first capacitors of the different sub-pixels could be substantially the same and the capacitance of the second capacitors of the sub-pixels are substantially the same. Alternatively, the capacitance of the first capacitors corresponding to the different color filters could be different and the capacitance of the second capacitors of the sub-pixel are made to be different, the sum of capacitance of the first capacitor and the capacitance of the second capacitor of each sub-pixel is substantially the same as the sum of the capacitance of the other sub-pixels. Accordingly, color shift and image sticking of an image may be suppressed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An active device array substrate comprising:
a substrate;
a plurality of scan lines, disposed on the substrate;
a plurality of data lines, disposed on the substrate, the plurality of scan lines and the plurality of data lines intersecting to define a plurality of sub-pixel regions on the substrate;
a plurality of pixels, each of the pixels comprising a plurality of sub-pixels, each of the sub-pixels respectively disposed in one of the sub-pixel regions, the each of the sub-pixels comprising:
at least a transistor, disposed on the substrate, electrically connected to a corresponding scan line of the plurality of scan lines and a corresponding data line of the plurality of data lines, and the transistor comprising a drain, a gate electrically connected to the corresponding scan line, and a source electrically connected to the corresponding data line;
a pixel electrode, wherein the pixel electrode and the drain are electrically connected;
a color filter, disposed within the one of the sub-pixel regions and underneath the pixel electrode, wherein a portion of the color filter is positioned between the pixel electrode and the corresponding scan line, the pixel electrode and the corresponding scan line are coupled to provide a first capacitance, and the drain and the corresponding scan line are coupled to provide a second capacitance; and
wherein in one of the plurality of pixels, coupling areas of the pixel electrodes corresponding to the different color filters and the corresponding scan lines are substantially different from each other so that the first capacitance of the plurality of sub-pixels are substantially the same, and the second capacitance of the plurality of sub-pixels are substantially the same.

2. The active device array substrate of claim 1, wherein in the one of the pixels, the color filters comprise at least a first color filter, a second color filter, and a third color filter, and a dielectric constant of the first color filter is ∈₁, a dielectric constant of the second color filter is ∈₂, a dielectric constant of the third color filter is ∈₃, and a thickness of the first color filter is D₁, a thickness of the second color filter is D₂, a thickness of the third color filter is D₃, and the pixel electrodes comprise a first pixel electrode, a second pixel electrode, and a third pixel electrode, and the coupling area of the first pixel electrode and the corresponding scan line is A₁, the coupling area of the second pixel electrode and the corresponding scan line is A₂, the coupling area of the third pixel electrode and the corresponding scan line is A₃, and a following relation is satisfied:
[(∈₁×A₁)/D₁]=[(∈₂×A₂)/D₂]=[(∈₃×A₃)/D₃].

3. The active device array substrate of claim 2, wherein ∈₁≠∈₂≠∈₃.

4. The active device array substrate of claim 2, wherein D₁≠D₂≠D₃.

5. The active device array substrate of claim 2, wherein ∈₁≠∈₂≠∈₃ and D₁≠D₂≠D₃.

6. An active device array substrate comprising:
a substrate;
a plurality of scan lines, disposed on the substrate;
a plurality of data lines, disposed on the substrate, and the plurality of scan lines and the plurality of data lines intersect to form a plurality of sub-pixel regions on the substrate;
a plurality of pixels, each of the pixels comprising a plurality of sub-pixels, each of the sub-pixels is disposed in one of the sub-pixel regions, and the each of the sub-pixels comprising:
at least a transistor, disposed on the substrate and electrically connected to a corresponding scan line of the plurality of scan lines and a corresponding data line of the plurality of data lines, and the transistor comprising a drain, a gate electrically connected to the corresponding scan line, and a source electrically connected to the corresponding data line;
a pixel electrode, wherein the pixel electrode and the drain are electrically connected;
a color filter, disposed within the one of the sub-pixel regions and under the pixel electrode, wherein a portion of the color filter is positioned between the pixel electrode and the corresponding scan line, the pixel electrode and the corresponding scan line are coupled to provide a first capacitance, and the drain and the corresponding scan line are coupled to provide a second capacitance; and
wherein in one of the pixels, the first capacitance in the plurality of sub-pixels are different because of the different color filters, and the second capacitance in the plurality of sub-pixels are substantially different, and a sum of the first capacitance and the second capacitance of each of the sub-pixels is substantially the same as the sum of the first capacitance and the second capacitance of other sub-pixels of the plurality of sub-pixels.

7. The active device array substrate of claim 6, wherein in the one of the pixels, the color filters comprise at least a first color filter, a second color filter, and a third color filter, and a dielectric constant of the first color filter is ∈₁, a dielectric constant of the second color filter is ∈₂, a dielectric constant of the third color filter is ∈₃, and a thickness of the first color filter is D₁, a thickness of the second color filter is D₂, a thickness of the third color filter is D₃, and the second capacitance of the each of the sub-pixels comprising the first color filter is Cg₁, the second capacitance of the each of the sub-pixels comprising the second color filter is Cg₂, the second capacitance of the each of the sub-pixels comprising the third color filter is Cg₃, and a following relation is satisfied:
[[(∈₁×A)/D₁]+Cg₁]=[[(∈₂×A)/D₂]+Cg₂]=[[(∈₃×A)/D₃]+Cg₃]

8. The active device array substrate of claim 6, wherein in the one of the pixels, a coupling area of the drain and the corresponding scan line of the each of the sub-pixels is substantially different from the coupling area of the drain and the corresponding scan line of other sub-pixels of the plurality of sub-pixels.
